(19) United States
(12) Patent Application Publication
(10) Pub. No.: US 2025/0306671 A1
(43) Pub. Date: Oct. 2, 2025

(54) INFORMATION PROCESSING SYSTEM, PROGRAM, AND INFORMATION PROCESSING METHOD

(71) Applicant: GREE HOLDINGS, INC., Tokyo (JP)

(72) Inventors: Ryo YABE, Tokyo (JP); Yousuke YAMANOUCHI, Kanagawa (JP)

(73) Assignee: GREE HOLDINGS, INC., Tokyo (JP)

(21) Appl. No.: 19/084,279

(22) Filed: Mar. 19, 2025

(30) Foreign Application Priority Data
Mar. 27, 2024 (JP) 2024-050993

(51) Int. Cl. G06F 3/01; G06V 20/40

(52) U.S. Cl. CPC G06F 3/011; G06V 20/40

(57) ABSTRACT

An information processing system for displaying an image of a three-dimensional virtual space viewed by a first user and a second user includes circuitry. The circuitry is configured to change at least one of a position and a direction of a virtual camera in the virtual space; acquire information transmitted from a user device used by the second user, the information including (i) identification information for identifying an object selected by the second user and (ii) a display request for the object; and set a display position of the object according to the position of the virtual camera and a position of a character object corresponding to the first user, based on the identification information of the object and the display request, and display on a display a virtual space image in which the object is arranged at the display position.

This application claims the benefit of priority from Japanese Patent Application No. 2024-050993 filed Mar. 27, 2024, the entire contents of the prior application(s) being incorporated herein by reference.

### TECHNICAL FIELD

This disclosure relates to an information processing system, a program, and an information processing method.

### BACKGROUND TECHNOLOGY

Some videos in which, for example, avatars appear display, on a display, virtual space images rendered from objects included in the field of view of a virtual camera. Among these videos, some are known in which a viewing user who views the video provides an object as a gift to a distributing user who distributes the video. A user device used by the viewing user transmits a display request for the object to be provided, to a server that manages distribution of the video. A user device of the distributing user and the user device of the viewing user display the object corresponding to the display request.

### SUMMARY

### Problems to Be Solved

In some of the above-described videos, the position and orientation of the virtual camera are changed based on user input operations. This allows the user to view any position in the virtual space.

However, when at least one of the position and direction of the virtual camera is changed, the object provided may move out of the field of view of the virtual camera. In this case, the distributing user may not be able to notice the object. As a result, the distributing user is unable to communicate with the viewing user, even though the object has been provided by the viewing user. This problem can occur not only in video distribution but also in any other application that displays a three-dimensional virtual space, such as a game.

### Means of Solving the Problems

The information system according to one aspect of this disclosure is an information processing system for displaying an image of a virtual space viewed by a first user and a second user, the information processing system comprising: a setting device that changes at least one of a position and a direction of a virtual camera in a three-dimensional virtual space; a communicator that acquires information transmitted from a user device used by the second user, the information including (i) identification information for identifying an object selected by the second user and (ii) a display request for the object; and an output controller that sets a display position of the object according to the position of the virtual camera and a position of a character object corresponding to the first user, based on the identification information of the object and the display request, and displays on a display device a virtual space image in which the object is arranged at the display position.

The program according to one aspect of this disclosure is a program for causing one or more computers to function as: a setting device that changes at least one of a position and a direction of a virtual camera in a three-dimensional virtual space; an output controller that outputs a virtual space image, which is an image of the virtual space seen from the virtual camera, to a display device viewed by a user; and a communicator that acquires information transmitted from another device used by another user, the information including (i) identification information for identifying an object selected by the other user and (ii) a display request for the object; wherein the output controller sets a display position of the object according to the position of the virtual camera and a position of a character object corresponding to the user based on the identification information of the object and the display request, and outputs the object to the display position.

The information processing method according to one aspect of this disclosure is an information processing method, wherein one or more computers: change at least one of a position and a direction of a virtual camera in a three-dimensional virtual space; output a virtual space image, which is an image of the virtual space as seen from the virtual camera, to a display device viewed by a user; obtain information transmitted from another device used by another user, the information including (i) identification information for identifying an object selected by the other user and (ii) a display request for the object; and set a display position of the object in accordance with the position of the virtual camera and a position of a character object corresponding to the user, based on the identification information of the object and the display request, and output the object to the display position.

The information processing method according to one aspect of this disclosure is an information processing method using one or more computers for displaying an image of a virtual space viewed by a first user and a second user, wherein the computers: change at least one of a position and a direction of a virtual camera in a three-dimensional virtual space; obtain information transmitted from a user device used by the second user, the information including (i) identification information for identifying an object selected by the second user and (ii) a display request for the object; and set a display position for the object in accordance with the position of the virtual camera and a position of a character object corresponding to the first user, and display, on a display device, a virtual space image in which the object is arranged at the display position.

### Effects

According to this disclosure, a plurality of users sharing a virtual space can smoothly interact with each other through object display requests.

### BRIEF DESCRIPTION OF DRAWINGS

FIG. 1 is a schematic diagram showing an embodiment of an information processing system in a first embodiment.

FIG. 2 is a diagram showing a hardware configuration of an information processing device of this embodiment.

FIG. 3 is a block diagram schematically showing functions of a user device of this embodiment.

FIG. 4 is a block diagram schematically showing functions of a management server of this embodiment.

FIG. 5 is diagram schematically showing user management information of this embodiment.

FIG. 6 is a diagram schematically showing provided object information of this embodiment.

FIG. 7 is a diagram schematically showing a display area of a provided object of this embodiment.

FIG. 8 is a diagram schematically showing a display area of a provided object of this embodiment.

FIG. 9 is a flowchart showing a procedure of a display process of this embodiment.

FIG. 10 is a diagram showing one example of a provided object of this embodiment.

FIG. 11 is a diagram explaining collaborative distribution of a second embodiment.

FIG. 12 is a diagram showing a display example of a provided object of a third embodiment.

FIG. 13 is a diagram explaining the display area of a provided object of a variation.

### MODES TO IMPLEMENT EMBODIMENTS

### Information Processing System Overview

An information processing system displays an image of a three-dimensional virtual space on a user device. The user device of the information processing system changes at least one of the position and direction of a virtual camera. The user device or a server acquires information transmitted from a user device used by a second user, which includes identification information for identifying an object and a display request for the object. The user device or server sets the display position of the object in accordance with the position of the virtual camera and the position of a character object corresponding to a first user based on the identification information of the object and the display request, and displays on the user device a virtual space image in which the object is arranged at a display position.

### First Embodiment

Below, a first embodiment of an information processing system, a program, and an information processing method is described. In this embodiment, the description will be for a distributing user distributing a video using a user terminal, and a viewing user viewing the video using a user terminal. The distributing user corresponds to a first user. The viewing user corresponds to a second user.

The video includes an image of a character object corresponding to the distributing user. The distributing user corresponds to the first user. The viewing user provides an object to the distributing user. This object is called the provided object. The viewing user is the second user. In this video distribution, the provided object is also called a gift object.

The provided object may be provided to support the distributing user. Furthermore, by providing the provided object, information about a user associated with the distributing user may be altered.

### Information Processing System

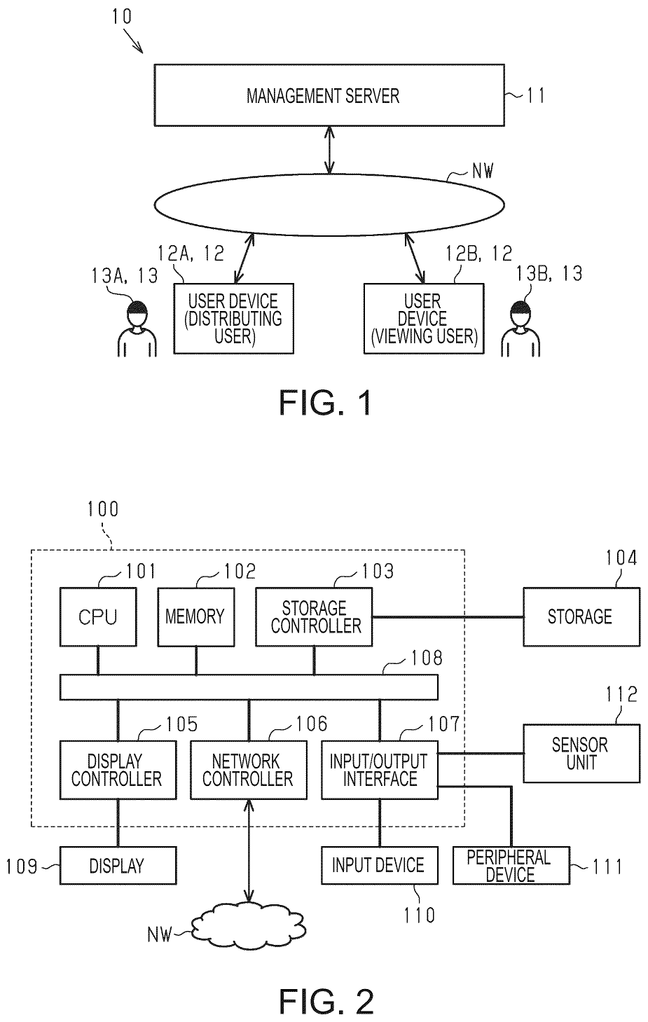

An information processing system 10 will be described with reference to FIG. 1. The information processing system 10 includes a management server 11 and user devices 12. The management server 11 and the user devices 12 are connected via a network NW.

In one embodiment, the management server 11 is managed by a platform provider that provides a platform (PF) for distributing and viewing videos in a virtual space.

The management server 11 includes one or more devices. In other words, the management server 11 may be a group of servers. The management server 11 is connected to the user devices 12 via a network NW such as the Internet. The user devices 12 are devices on which a program for distributing and viewing videos is installed, or devices used by users 13 who use a video providing service for distributing and viewing videos using a web browser or the like. The management server 11 is responsible for relaying data related to distribution of videos.

FIG. 1 shows a distributing user 13A and a viewing user 13B. The distributing user 13A is a user 13 who distributes a video using a user device 12. The user 13B is a user 13 who views the distributed video on a user device 12. One user 13 can be the distributing user 13A at one time and the viewing user 13B at another time. That is, the user 13 is the distributing user 13A when distributing a video, and the viewing user 13B when viewing a video. In addition, the user device 12 that distributes a video is called a distributing user device 12A, and the user device 12 that displays a video for viewing is called a viewing user device 12B. The user devices 12 can switch between a mode for distributing a video and a mode for displaying a video for viewing. In this embodiment, when the description does not distinguish between the distributing user 13A and the viewing user 13B, each is simply referred to as a user 13. In addition, when the description does not distinguish between the distributing user device 12A and the viewing user device 12B, each is simply referred to as a user device 12.

### Hardware

The hardware of the user device 12 will be described with reference to FIG. 2. The user device 12 is a smartphone (multi-function phone terminal), a tablet terminal, a personal computer, a console game machine, a wearable computer, or any other information processing device capable of playing videos. A wearable computer may have a screen on which the user can watch videos, and may be, for example, a head-mounted display worn on the user's head or a glasses-type wearable terminal device. The user device 12 may be a device that operates independently, or may be a set of multiple devices that are connected so as to be capable of transmitting and receiving various data with each other. An example of the latter user device 12 is a system that performs tracking using an outside-in method.

The user device 12 includes a processing circuit 100, a storage 104, a sensor unit 112, a display 109, an input device 110, and a peripheral device 111. The user device 12 illustrated in FIG. 2 includes a sensor unit 112 that detects movement of the distributing user 13A. The sensor unit 112 may be a device separate from the user device 12 that can communicatively connect to the user device 12.

The processing circuit 100 includes a CPU 101, which is a processor that executes one or more of the control processes disclosed in this specification, and a memory 102. Processing data and instructions may be stored in the memory 102. These processing data and instructions may also be stored in the storage 104, which is a storage medium disk such as a hard drive (HDD) or a portable storage medium, or may be stored in a storage medium provided separately from the processing circuit 100. The storage 104 is connected to the CPU 101 via a storage controller 103 and a bus 108. In this embodiment, an application is stored in the storage 104. The application includes a program for distributing and viewing videos and various data necessary for execution of the program.

Each function disclosed in this specification may be implemented using circuitry that may include not just the CPU 101 but also general-purpose processors, special-purpose processors, integrated circuits, ASICs (Application Specific Integrated Circuits), other conventional circuits, and/or combinations thereof, configured or programmed to perform the disclosed functions. The processor is a processing circuit or circuitry because transistors and other circuitry are included therein. The processor may be a programmed processor that executes a program stored in the memory. In this disclosure, a device or means such as the processing circuit is hardware that performs or is programmed to perform the mentioned functions. The hardware may be any hardware disclosed in this specification, or any otherwise known hardware, that is programmed or configured to perform the mentioned functions.

Furthermore, the processor is not limited by the form of the computer-readable medium on which the instructions of the process are stored. For example, the instructions may be stored on a CD or DVD, or on a FLASH memory, RAM, ROM, PROM, EPROM, EEPROM, hard disk, or other non-transitory computer-readable medium of an information processing device with which the processing circuit 100 communicates, such as a server or a computer. The process may also be stored in network-based storage, cloud-based storage, or other mobile-accessible storage, and may be executable by the processing circuit 100.

In addition, the descriptions or blocks in the flowcharts disclosed in this specification may be understood as representing modules, segments, or portions of code that include one or more executable instructions for implementing a particular logical function or step in the process. In addition, the descriptions or blocks in the flowcharts disclosed in this specification may perform two or more functions or steps in a different order than that depicted in the drawings or the specification, such as substantially simultaneously or in reverse order.

The hardware elements for realizing the processing circuit 100 may be realized by various circuit elements. Furthermore, each function disclosed in this specification may be realized by a circuit that includes one or more processing circuits.

The processing circuit 100 also includes a network controller 106 for connecting to the network NW. The network NW may be a public network such as the Internet, or a private network such as a local area network (LAN) or a wide area network (WAN), or any combination thereof, and may include a public switched telephone network (PSTN) or an integrated services digital network (ISDN, registered trademark), or a sub-network. The network NW may also be a wired network such as an Ethernet (registered trademark) network, a universal serial bus (USB) cable, or the like, or a wireless network such as a cellular network, including 3G, 4G, and 5G wireless cellular systems. The wireless network may also be Wi-Fi (registered trademark), wireless LAN, Bluetooth (registered trademark), or other forms of wireless communication known in the art. Furthermore, the network controller 106 may conform to other direct communication standards such as Bluetooth (registered trademark), Near Field Communication (NFC), infrared, or the like.

The processing circuit 100 further includes a display controller 105 and an input/output interface 107. The display controller 105, the network controller 106, and the input/output interface 107 are connected to the bus 108. The display controller 105 is connected to the display 109. The input/output interface 107 is connected to the input device 110 and the peripheral device 111.

The sensor unit 112 will now be described. The sensor unit 112 is one or more sensors that detect data indicating movement of the user 13. The movement of the user 13 includes face motion indicating a change in the facial expression of the user and body motion indicating a change in the position and orientation of the body of the user relative to the sensor unit 112. Face motion includes movements such as blinking, and opening and closing of the mouth. A commonly known sensor can be used as the sensor unit 112. The sensor unit 112 has a sensor that measures the distance to a measurement target by shining light on the measurement target. As such a sensor, for example, a true depth sensor or a “LIDAR” (Light Detection and Ranging, or Laser Imaging Detection and Ranging) sensor, or the like, can be used. As a result, the sensor unit 112 captures accurate facial data. An arithmetic processor of the sensor unit 112 generates various information based on a depth map and an infrared image, and compares the information with registered reference data to calculate the depth of each point on the face (the distance between each point and a near-infrared camera) and positional deviations other than in the depth direction. In another example, the sensor unit 112 includes a ToF sensor that measures the time of flight from when light is shone toward the measurement target such as the face of the user until the light is reflected back, or the phase difference between the shined light and the reflected light, using a distance measurement method other than the above-mentioned method. The ToF sensor calculates the distance to the measurement target based on the time of flight or the phase difference. Alternatively or additionally, the sensor unit 112 may include a camera that captures the face of the user and an image processor that processes the data captured by the camera.

The sensor unit 112 outputs face motion and body motion to the processing circuit 100 as tracking data. The tracking data is data that detects the direction and position of the user's body parts. The tracking data is included in the motion data. In this embodiment, a character object to which the motion data detected by the sensor unit 112 is applied is called an avatar object. The motion data refers to general data for moving the avatar object corresponding to the user 13.

For example, the motion data includes emote data in addition to the tracking data. The emote data is data for making the avatar object perform a pre-registered specified movement such as a “clap.” The pre-registered movement of the avatar object is referred to hereafter as an “emote.”

The sensor unit 112 may also have a function for tracking not only the face of the user but also a hand (hand tracking). The sensor unit 112 may also include a sensor that detects the position or orientation of a human body part other than the hand. The sensor unit 112 may further include a sensor that detects speed and acceleration, a sensor that detects direction and orientation (such as a gyro sensor), or the like. The sensor unit 112 may also have a spatial mapping function that recognizes objects in the real space in which the user exists and maps the recognized objects onto a spatial map, that is, creates a map of the positions of the recognized objects in the real space.

The input device 110 may be a touch panel, a keyboard, a mouse, a controller operated by the user's hands (for example, a game controller such as a game pad or a joystick), or an operation button(s) provided on the housing of the user device 12. The controller may have various commonly known sensors built in, such as an acceleration sensor, an inertial measurement unit (IMU) such as a gyroscope, or the like. In another example, the input device 110 may be a tracking device that identifies the user's hand movement, eye movement, head movement, line-of-sight direction, or the like. In this embodiment, for example, based on the user's hand movements, the user's instructions can be determined, and various operations can be performed, such as starting or ending distribution of a video, evaluating a message or a video, or displaying a specified object.

The peripheral device 111 includes a microphone that collects sounds in the real world, such as the voice of the user 13, and a speaker that outputs sound effects and the voices of other users 13.

The management server 11 has a processing circuit 100 and a storage 104 similar to those of the user device 12. In the management server 11, the input device 110, the peripheral device 111, the sensor unit 112, the display 109, and the like, can be omitted.

### User Device

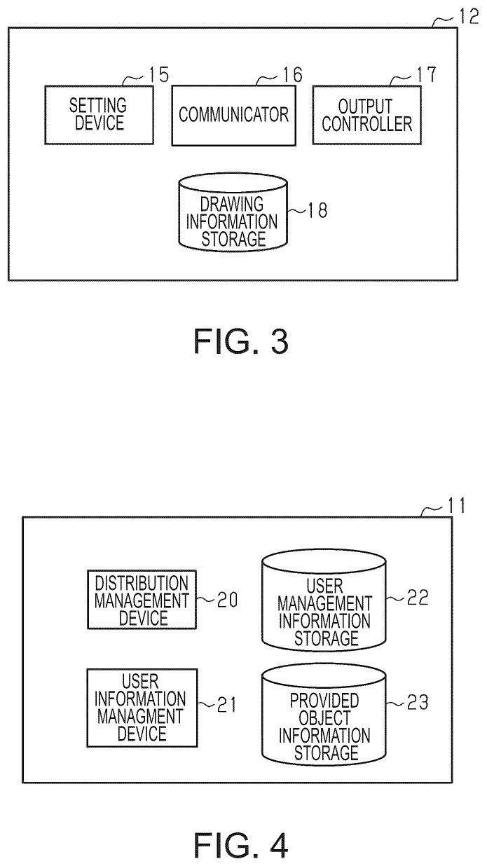

The functions of the user device 12 will be described with reference to FIG. 3. The user device 12 functions as a setting device 15, a communicator 16, and an output controller 17 by the processing circuit 100 executing programs recorded in the storage 104. The user device 12 also includes a drawing information storage 18.

The setting device 15 changes at least one of the position and the direction of the virtual camera in the three-dimensional virtual space.

The communicator 16 receives data for displaying the video transmitted by the distributing user device 12A (other device) from the management server 11. The communicator 16 acquires identification information for identifying a provided object selected by the viewing user 13B, which is information transmitted from another viewing user device 12B, and a display request for the provided object.

The output controller 17 displays a video, which is an image of the virtual space that the user 13 sees, on the display 109 based on the data for displaying the video, and outputs from the speaker the sound spoken by the distributing user 13A. The output controller 17 sets the display position of the provided object in accordance with the position of the virtual camera and the position of the avatar object corresponding to the distributing user 13A, based on the display request and the identification information of the provided object acquired by the communicator 16. The output controller 17 also displays the virtual space image in which the provided object is placed at that display position on the display 109, which is a display device. Display attributes are associated with the display area.

The drawing information storage 18 stores drawing information. The drawing information includes data for displaying videos, data for displaying a setting screen, and the like. The drawing information is updated by the management server 11 as appropriate.

### Management Server

The management server 11 will be described with reference to FIG. 4. The management server 11 functions as a distribution management device 20 and a user information management device 21 by the processing circuit 100 executing a program stored in the storage 104. The management server 11 also includes a user management information storage 22 and a provided object information storage 23. These storages 22 and 23 are constituted by the storage 104.

The distribution management device 20 starts distribution of a video in response to a distribution request from the distributing user device 12A. In addition, the distribution management device 20 transmits data for displaying the video to the viewing user device 12B in response to a viewing request from the viewing user device 12B.

The distribution management device 20 receives, from the viewing user device 12B, identification information for identifying a provided object selected by the viewing user 13B and a display request for the provided object. In addition, the distribution management device 20 transmits the provided object identification information and display request to the distributing user device 12A and the viewing user device 12B.

The user information management device 21 updates user management information 24 based on a price associated with the provided object identification information. If the provided object requires a price, the user information management device 21 updates the user management information 24 of the viewing user 13B so as to subtract the price. The user information management device 21 also updates the user management information 24 of the distributing user 13A so as to add a reward for the provided object being provided to the distributing user 13A.

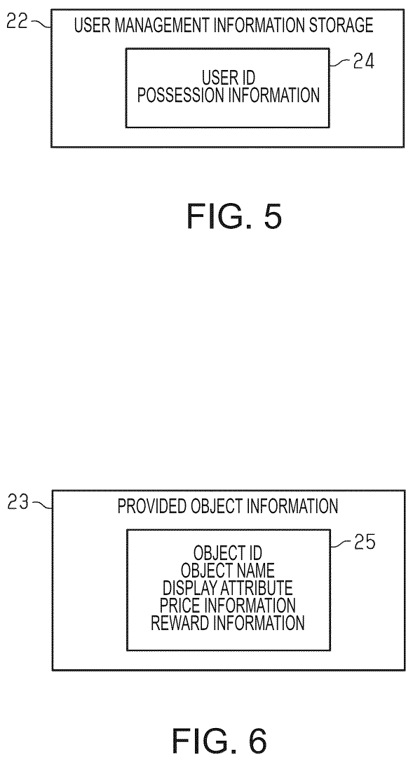

FIG. 5 shows an example of the user management information 24 stored in the user management information storage 22. The user management information 24 is recorded for each user. The user management information 24 includes a user ID (identifier), which is the user's identification information, and possession information. The possession information indicates the value that the user 13 possesses in order to acquire items and the like and to make display requests for gift objects in an application or a platform that provides the application. The value includes, for example, coins. The coins can be used as the price for acquiring items, a lottery (gacha), or a display request for the provided object. The coins can be purchased by the user 13. The possession information may also include accumulated points that are awarded based on activities of the user 13. The activities may include the distribution and viewing of videos, participation in an event, or the like. Points are awarded based on the activities of the user 13, and the points are added to the accumulated points. The possession information may also include information on cryptocurrency or electronic money usable in the real world.

FIG. 6 shows an example of provided object information 25 stored in the provided object information storage 23. The provided object information 25 includes an object ID, an object name, display attribute, price information, and reward information. The object ID is identification information for a provided object that can be selected by a viewing user. The object name is the name of the provided object. The display attribute indicates an attribute when the provided object is displayed. The display attribute may be a group or a type. The display attribute may also be a tag that can be assigned to an object. The price information is information indicating the price paid by the viewing user for providing the provided object. The price information is, for example, coins or points, which are the price for providing the provided object. The reward information is information indicating the reward received by the distributing user who received the provided object.

### Video Distribution and Viewing Method

Next, a video distribution and viewing method will be described. Upon receiving a distribution request and identification information of a specified virtual space, the management server 11 generates a room (distribution frame) in the virtual space specified by the user 13.

Distribution frames in which videos are being distributed are displayed on a list screen displayed on each user device 12. A viewing user 13B can start viewing a video by selecting the distribution frame the user wants to view from the list screen. The management server 11 transmits data (asset data) for displaying the virtual space to the user device 12.

The video distribution and viewing method can be classified as a client rendering method, a browser rendering method, a video distribution method, or a server distribution method, depending on the device and method used for rendering. Other methods may be used as long as either the user device 12 or the management server 11 can perform image processing. In this embodiment, the client rendering method is used.

In the client rendering method, each user device 12 renders objects by executing a program. The user device 12 stores three-dimensional model data of an avatar object and objects other than the avatar object. Objects other than the avatar object are also called physical objects. Physical objects include provided objects. The three-dimensional model data of the avatar object includes data of main body parts that constitute the main body of the avatar object and attachment parts attachable to the avatar object. The data of the main body parts includes polygon data, skeletal data (bones) for expressing movement of the avatar object, texture data, and the like. Attachment parts include texture data and the like. The distributing user 13A can set the attachment parts of the avatar object corresponding to the user, in accordance with the user's preferences. The model data of the physical objects other than the avatar object includes polygon data, texture data, and the like.

The output controller 17 performs drawing using video data including motion data and identification information (part IDs) indicating the parts of each object. The output controller 17 also transmits video data including the motion data, the avatar object, and virtual camera coordinates to the management server 11. The output controller 17 also transmits part IDs indicating each part of the avatar object to the management server 11 at a specified timing (for example, at the start of distribution). The management server 11 transmits the video data to the viewing user device 12B, and the like. The viewing user device 12B receives the data from the management server 11. The viewing user device 12B then uses the received data to render images of the avatar object of the distributing user 13A and the physical objects.

The output controller 17 also transmits audio data based on audio collected by the microphone to the management server 11. The management server 11 transmits the audio data to the viewing user device 12B. A timestamp is attached to the motion data and the audio data.

The output controller 17 of the viewing user device 12B receives the video data and the audio data for displaying the video from the management server 11. The output controller 17 then uses the video data to render an image including the avatar object corresponding to the distributing user 13A.

The output controllers 17 of the distributing user device 12A and the viewing user device 12B also receive from the management server 11 data such as messages posted by other users. Each output controller 17 combines images in which the avatar object and other objects are rendered with the posted messages and notifications and the like to generate output data, and outputs the output data to the display 109. Each output controller 17 also synchronizes the audio data with the video data based on the timestamp and outputs such from the speaker.

The distributing user device 12A and the viewing user device 12B may display videos in different ways. For example, the distributing user device 12A may display videos with a client rendering method, while the viewing user device 12B may display videos with a browser rendering method. In addition, the user may be able to select the method of displaying videos. For example, some viewing user devices 12B may display videos with a client rendering method, while other devices may display videos with a browser rendering method.

### Virtual Space

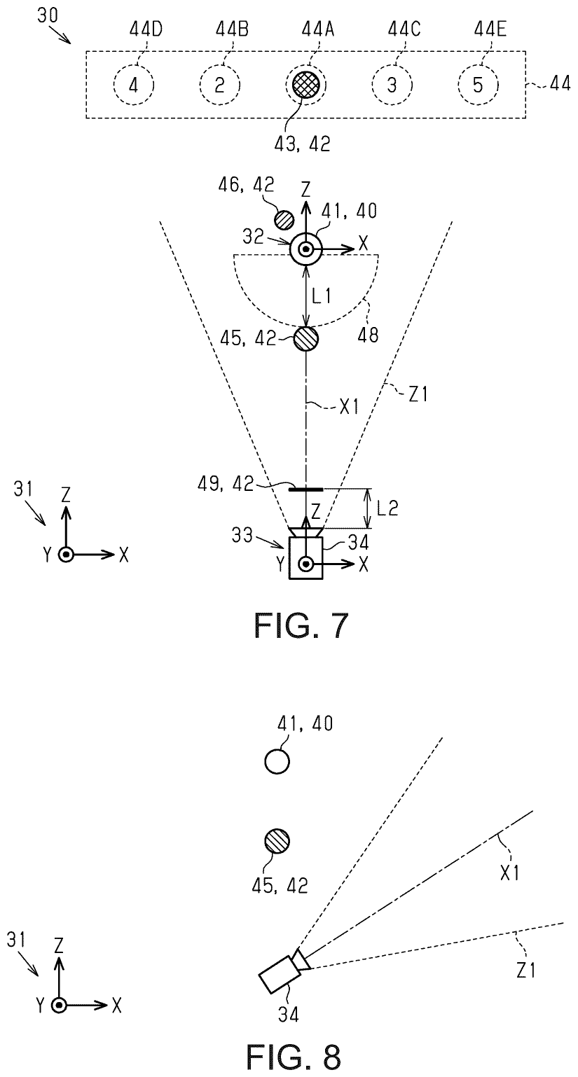

An example of a virtual space 30 will be described with reference to FIG. 7. The virtual space 30 includes a plurality of objects. The objects located in the virtual space 30 include an avatar object 41 and physical objects. The avatar object 41 is included in a character object 40 in the broad sense. FIG. 7 is a view of the avatar object 41 and the like as viewed from above.

A world coordinate system 31 indicating positions in the virtual space is set in the virtual space 30. The world coordinate system 31 is a coordinate system having an X-axis, a Y-axis, and a Z-axis. The world coordinate system 31 is also called a global coordinate system. The position of each object can be specified by coordinates in the world coordinate system 31. The coordinates specified in the world coordinate system 31 include coordinates (X, Y, Z) expressed in a Cartesian coordinate system. These coordinates may also include rotational coordinates (roll, pitch, yaw) for each coordinate axis. Each object has its own object coordinate system 32 set. The object coordinate system 32 is a coordinate system having an X-axis, a Y-axis, and a Z-axis. The orientation and movement of the avatar object 41 can be specified by the coordinates in the Cartesian coordinate system or by rotational coordinates.

In the virtual space 30, a virtual camera 34 is located, the field of view of which changes based on input operations of the distributing user 13A. A camera coordinate system 33 is set for the virtual camera 34. For example, the camera coordinate system 33 includes coordinates (X, Y, Z) specified in a three-dimensional Cartesian coordinate system, as well as rotational coordinates (Xθ, Yθ, Zθ) centered on each coordinate axis.

The output controller 17 performs rendering based on the coordinates of objects included in a specified field of view Z1 (e.g., a field-of-view cone having an approximately conical shape) centered on the virtual optical axis X1 of the virtual camera 34. The output controller 17 then displays on the display 109 the image generated by the rendering. Rendering here refers to a drawing process that includes acquisition of the position of the virtual camera 34, perspective projection, hidden surface removal based on depth information associated with each object, shading, texture mapping, and the like.

At least one of the position and direction of the virtual camera 34 can be changed based on the input operations of the distributing user 13A. In this embodiment, both the position and direction of the virtual camera 34 can be changed. The virtual space 30 may include an area where the virtual camera 34 can be placed and an area where the virtual camera 34 cannot be placed.

The output controller 17 sets the virtual camera 34 based on the input operations of the distributing user 13A. If the avatar object 41 is included in the field of view Z1, an image of the avatar object 41 can be displayed on the screen.

The camera coordinate system 33 specifies the camera direction, panning, tilting, and other operations. In addition, the virtual camera 34 may be able to zoom in and out based on the input operations of the distributing user 13A.

In this embodiment, the virtual camera 34 may be associated with the avatar object 41 so as to maintain a positional relationship with respect to the avatar object 41. For example, the output controller 17 causes the virtual camera 34 to follow the moving avatar object 41 during a period when the camera is not being operated. At this time, the virtual camera 34 may be set behind the avatar object 41 in order to display a rear view of the avatar object 41 and an image of the virtual space 30 in front of the avatar object 41.

In this case, the output controller 17 obtains the moving direction indicated by the distributing user 13A on the screen as a first direction. The output controller 17 converts the first direction into a second direction as the moving direction in the world coordinate system 31, and moves the avatar object 41 in the second direction. The output controller 17 also sets the virtual camera 34 at a position that is a specified offset distance away from the avatar object 41 in a specified relative direction that uses the avatar object 41 as a reference. Then, when the avatar object 41 moves, the output controller 17 moves the virtual camera 34 in the second direction while keeping the relative distance between the avatar object 41 and the virtual camera 34 constant. This restrains the avatar object 41 from moving away from the virtual camera 34, and therefore restrains the avatar object 41 from leaving the screen or being displayed so small as to be difficult to see. Even when the virtual camera 34 is made to follow the avatar object 41, the user 13 can change at least one of the position and direction of the virtual camera 34 by input operations.

The virtual camera 34 may also be set to a position specified by the user 13 within an allowable area, regardless of the position of the avatar object 41.

### Provided Objects

Provided objects 42 may be displayed in response to display requests from multiple viewing users 13B. For this reason, if many provided objects 42 are continuously displayed on the screen, the provided objects 42 will occupy most of the screen. As a result, the essential avatar object 41 may be hidden by the provided objects 42. For this reason, many of the provided objects 42 are displayed dynamically. For example, the output controller 17 erases the provided objects 42 after displaying such for a specified time, or makes the provided objects 42 exit the screen after displaying such on the screen.

However, even if the provided objects 42 are dynamically displayed, depending on the number and size of the provided objects 42, some of the provided objects 42 or the avatar object 41 may be difficult to see on the screen. For this reason, the output controller 17 displays the provided objects 42 in separate display areas according to the display attributes of the provided objects 42.

In this embodiment, fixed display objects, intermediate display objects, attached objects, rear display objects, and two-dimensional objects are set as display attributes of the provided objects 42. The display attributes are included in the provided object information 25. The output controller 17 sets the display positions of the provided objects 42 within the display areas corresponding to the display attributes of the provided objects 42.

Fixed display objects 43 are displayed in a specified fixed display area 44 among the areas in which the provided objects 42 can be displayed.

The fixed display objects 43 may include objects having a larger display size than other types of provided objects 42. This prevents this type of fixed display object 43 from blocking other objects. The fixed display objects 43 may include objects that are larger in display size than the avatar object 41. For example, this type of fixed display object 43 is wallpaper.

The fixed display object 43 may include objects that require a higher price than the other provided objects 42. The fixed display objects 43 may also include objects that are placed in the virtual space 30 for a long time.

Examples of the fixed display objects 43 include objects that imitate wallpaper, as well as objects that imitate wall hangings (scrolls). The fixed display objects 43 may also include objects that are intended to be placed side by side. Specifically, these include glasses that are stacked in a tower or pyramid shape, and flower stands that are decorated with flowers on a stand. A fixed display object 43 may display the account name of the viewing user who selected it. In the fixed display area 44, display positions 44A to 44E of the fixed display objects 43 are set together with their display order. In FIG. 7, the display position 44A at the center is first in the display order.

An intermediate display object 45 is an object displayed between the position of the virtual camera 34 and the position of the avatar object 41 in a depth direction parallel to the optical axis X1 of the virtual camera 34, when the avatar object 41 is included in the field of view Z1 of the virtual camera 34. In other words, when the avatar object 41 is included in the field of view Z1 of the virtual camera 34, the intermediate display object 45 is displayed at a position closer to the virtual camera 34 than the avatar object 41. The display position of the intermediate display object 45 is set to a position where the relative distance from the avatar object 41 is a specified distance L1 (offset distance). The intermediate display object 45 is a three-dimensional object. The intermediate display object 45 being displayed at the specified distance L1 from the avatar object 41 may mean, for example, that when multiple intermediate display objects 45 are displayed together as an object group, the distance to one of the intermediate display objects 45 is the specified distance L1. In this case, the multiple intermediate display objects 45 may be displayed with their center points separated from each other by a separation distance. Alternatively, in the case of a large intermediate display object 45, the distance from the avatar object 41 to a specified point (such as the center point or center of gravity) of the intermediate display object 45 may be the specified distance L1.

A provided object 42 that is desired to be displayed together with the avatar object 41 is classified as an intermediate display object 45. The intermediate display object 45 is displayed closer to the avatar object 41 than other provided objects 42. For example, the intermediate display object 45 is an object with which the avatar object 41 can interact. Interaction means that the avatar object 41 holds, touches, or throws the intermediate display object 45. When expressing the interaction of the avatar object 41, it is possible to express a more natural movement by displaying the subject provided object 42 near the avatar object 41. As an example of this aspect, the output controller 17 identifies an indicated intermediate display object 45 based on the position indicated by the distributing user 13A on the touch panel. At this time, the output controller 17 may operate the avatar object 41 so that its hand reaches the position of the indicated intermediate display object 45. The output controller 17 then associates the avatar object 41 with the indicated intermediate display object 45. For example, the output controller 17 sets the intermediate display object 45 as a child object that has a parent-child relationship with the hand of the avatar object 41. This causes the intermediate display object 45 to follow the movement of the avatar object 41.

As illustrated in FIG. 7, the intermediate display object 45 may be displayed at any position within a semicircular area 48 centered on the avatar object 41. The radius of the area 48 is the specified distance L1. The intermediate display object 45 may be displayed at a position on the optical axis X1 of the virtual camera 34, and at the specified distance L1 away from the avatar object 41.

The intermediate display object 45 may be set with a component that exhibits physical behavior. As a result, after being displayed in the virtual space 30, the intermediate display object 45 falls due to a set gravity. Also, if a part of the intermediate display object 45 overlaps with a part of another intermediate display object 45 or with the avatar object 41, such collides with that intermediate display object 45. If multiple intermediate display objects 45 are displayed simultaneously in a video, the positions at which they appear may be adjusted so as to not overlap.

As shown in FIG. 8, even if the avatar object 41 is not included in the field of view Z1 of the virtual camera 34, the intermediate display object 45 is displayed at a position between the position of the virtual camera 34 and the position of the avatar object 41, and at the specified distance L1 from the avatar object 41. For example, the specified distance L1 between a provided object 42 and the avatar object 41 may be shorter than the distance between the provided object 42 and the virtual camera 34.

The distributing user 13A basically adjusts the position and orientation of the virtual camera 34 so as to display the avatar object 41. Therefore, as shown in FIG. 8, even if the avatar object 41 is no longer included in the field of view Z1 of the virtual camera 34, it is assumed that this state is temporary. Therefore, if the output controller 17 displays the intermediate display object 45 in the above-described position, the intermediate display object 45 can be recognized when the distributing user 13A moves the virtual camera 34 so as to display the avatar object 41. When the position of the provided object 42 is set according to the position of the avatar object 41 and the position of the virtual camera 34, if an obstruction (e.g., a virtual object blocking the view of the provided object 42 by the virtual camera 34) is present between the provided object 42 and the virtual camera 34, the position of the provided object 42 may be set closer than the obstruction to the virtual camera 34.

An attached object is an object that is associated with a part of the avatar object 41, although not depicted in the drawings. For example, if the attached object is a sword object, the attached object is associated with the hand of the avatar object 41. As a result, the avatar object 41 is displayed as if it is holding the attached object in its hand. In addition, when the attached object is displayed, the output controller 17 may automatically cause the avatar object 41 to perform an action associated with the attached object. For example, this action may be an action in which the avatar object 41 swings the attached object, which is a sword, from top to bottom. The attached object may also be a clothing object. For example, the attached object may be clothing such as a T-shirt, or an accessory such as a hat. The attached object may also be a facial expression of the avatar object 41.

The output controller 17 may display the attached object as an attachment candidate instead of immediately associating such with a part of the avatar object 41. The distributing user selects one from one or more attachment candidates. The output controller 17 accepts the selection operation. The output controller 17 then specifies the part or the like of the avatar object 41 that is set as an attribute of the selected attachment candidate, and displays the attachment candidate in association with the specified part.

As shown in FIG. 7, a rear display object 46 is displayed at a position behind the avatar object 41 in the depth direction (Z direction) that uses the virtual camera 34 as a reference. The Z direction is the direction away from the virtual camera 34. In other words, the rear display object 46 is displayed at a position farther away from the position of the avatar object 41 as viewed from the virtual camera 34. The rear display object 46 may execute a preset action. For example, the action may be an action of moving diagonally downward. As a result, for example, a “shooting star” rear display object 46 is displayed as if flowing diagonally downward.

A two-dimensional object 49 is an object that can be expressed in two-dimensional coordinates. In FIG. 7, the two-dimensional object 49 is displayed large for convenience, but is of a size that does not block the avatar object 41. The two-dimensional object 49 is displayed at a position within the field of view Z1 and at a specified distance L2 (offset distance) from the virtual camera 34. The output controller 17 continually displays the two-dimensional object 49 on the screen, included within the field of view Z1 of the virtual camera 34. Specifically, the output controller 17 may set an invisible plane object for displaying the two-dimensional object 49 in the virtual space 30, and display the two-dimensional object 49 on the invisible plane object. Alternatively, the output controller 17 may specify the field of view Z1 of the virtual camera 34, and display the two-dimensional object 49 in the field of view Z1.

Even if the field of view Z1 of the virtual camera 34 does not include the avatar object 41, the output controller 17 displays the two-dimensional object 49 so as to be displayed on the screen. The two-dimensional object 49 is, for example, a stamp showing support for the distributor, evaluation of the video, or the like. Because the two-dimensional object 49 is a direct message to the distributor, it is preferable for the two-dimensional object 49 to continually be displayed on the screen.

The display time of the intermediate display object 45 (first object) may be longer than the display time of the two-dimensional object 49 (second object). The display time of the intermediate display object 45 can be adjusted by controlling physical behavior. For example, the display time can be extended by slowing down the falling speed of the intermediate display object 45, causing the object to bounce, making the movement trajectory be a spiral, or making the movement trajectory meander (bend).

The price of the intermediate display object 45 (first object) may be higher than the price of the two-dimensional object 49 (second object). One of the reasons for this is that it takes more time and effort for a developer to create a three-dimensional object using an information processing device than to create a two-dimensional object.

### Operation

A process of the user device 12 displaying the provided object 42 will now be described. For example, video distribution is performed in a distribution room generated for each distributing user 13A. The distribution room is a space partitioned by walls and a floor. Alternatively, video distribution may be performed in a world such as a virtual exhibition hall or live venue shared by an unspecified number of users 13.

At a specified timing, the user device 12 receives, from the management server 11, drawing data for drawing each object such as the avatar object 41 and the provided object 42, and records this in the storage 104. The timing of receiving the drawing data is not particularly limited, and may include when logging in, when starting to watch a video, when starting to distribute a video, when receiving a display request, or the like. In the description below, it is assumed that the user device 12 has received the drawing data in advance.

After distribution of the video starts, the setting device 15 of the distributing user device 12A sets the virtual camera 34 to the position and orientation indicated by the distributing user 13A based on the input operation of the distributing user 13A. The communicator 16 of the distributing user device 12A also transmits the position and orientation of the virtual camera 34 to the management server 11. The setting device 15 of the viewing user device 12B sets the virtual camera 34 based on the position and orientation received from the management server 11.

The viewing user device 12B displays a list of provided objects 42 on the display 109 based on the input operation of the viewing user 13B. The viewing user device 12B accepts the selection operation of the viewing user 13B and selects a provided object 42. The communicator 16 transmits the identification information of the provided object 42 selected by the viewing user 13B and a display request to the management server 11 based on the input operation of the viewing user 13B. At this time, the viewing user device 12B may transmit the identification information of the distributing user 13A, the identification information assigned for each distribution, or the identification information of the room or world.

The management server 11 transmits, to each user device 12, information including the identification information of the provided object 42, the display request, and the identification information of the viewing user 13B who ordered transmission of the display request. The management server 11 may also perform price processing and reward processing for the provided object 42. Upon determining that the provided object 42 selected by the viewing user 13B requires a price, the management server 11 updates the user management information 24 to subtract the price. Upon determining that the provided object 42 provides a reward to the distributing user 13A, the management server 11 updates the user management information 24 to add the reward.

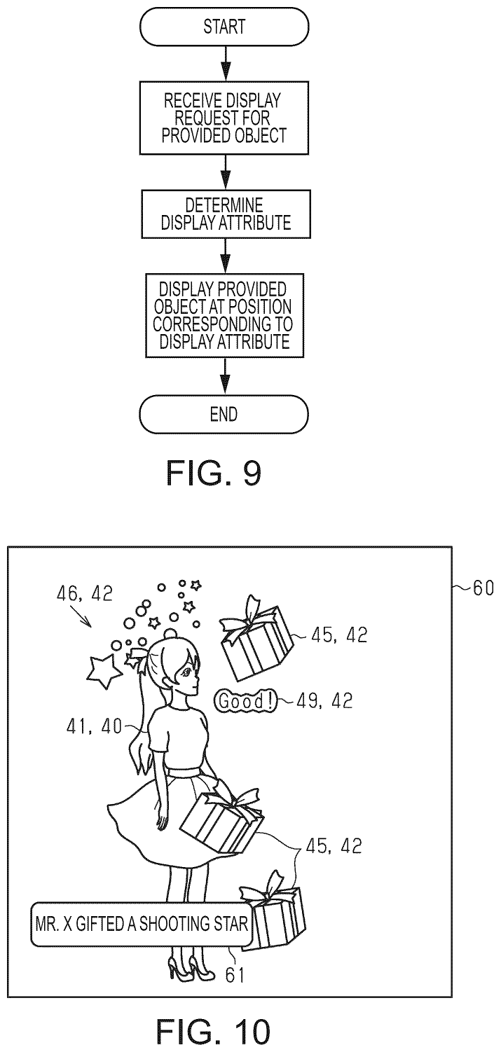

As shown in FIG. 9, the communicator 16 of the user device 12 acquires information including a display request for the provided object 42 from the management server 11 (step S1). The information acquired at this time includes the display request, as well as the identification information of the provided object 42 and the identification information of the viewing user 13B.

When the display request for the provided object 42 is received, the output controller 17 determines a display attribute of the provided object 42 (step S2). The display attribute may be received by the communicator 16 together with the identification information of the provided object 42. Alternatively, the output controller 17 may determine the display attribute using information of the provided object 42 stored in the storage 104.

The output controller 17 displays the provided object 42 at a position in accordance with the display attribute (step S3). After identifying an area in accordance with the display attribute, the output controller 17 may identify one position within the area as the appearance position. Alternatively, as described above, the output controller 17 may identify one position corresponding to the display attribute as the appearance position. Furthermore, the output controller 17 provides a notification of the provision of the provided object 42 by the viewing user 13B based on the received identification information of the viewing user 13B.

### Screen Display

An example of a screen displayed by the user device 12 will be described with reference to FIG. 10. FIG. 10 shows an example of a virtual space screen 60 displayed on the display 109 by the distributing user device 12A. GUI elements such as buttons operated by the distributing user 13A are omitted from the illustration. The virtual space screen (viewing screen) displayed by the viewing user device 12B is almost the same as the virtual space screen 60 displayed by the distributing user device 12A, except that the GUI elements thereof are different from the GUI elements for the distributing user 13A.

In the screen shown in FIG. 10, the virtual camera 34 (omitted in FIG. 10) is set to the right of the avatar object 41. When the avatar object 41 is included in the field of view Z1, intermediate display objects 45 are displayed in front of the avatar object 41, that is, between the virtual camera 34 and the avatar object 41. “In front” means in front of the position of the avatar object 41 as seen from the virtual camera 34, and does not necessarily mean the front where the face of the avatar object 41 is located. In other words, the relative direction of the virtual camera 34 and the avatar object 41 does not matter. Intermediate display objects 45 that perform physical behavior fall from their appearance position. The fallen intermediate display objects 45 land on the floor surface or the like.

A rear display object 46 is displayed behind the avatar object 41. “Behind” here refers to the rear of the position of the avatar object 41 as viewed from the virtual camera 34, and does not necessarily mean the rear where the back of the avatar object 41 is located.

A two-dimensional object 49 is displayed in front of the intermediate display object 45 and the rear display object 46. The two-dimensional object 49 is displayed so as to be included in the field of view Z1 of the virtual camera 34. An attached object is displayed in association with a part of the avatar object 41, such as a T-shirt associated with the upper body shown in FIG. 10.

The virtual space screen 60 also includes a notification 61. The notification 61 is automatically generated by the management server 11 or is posted by the viewing user 13B. The notification 61 includes the name of the account of the viewing user 13B and the name of the provided object 42 provided by that viewing user 13B. Therefore, the distributing user 13A can express gratitude to, or call out to, the viewing user 13B.

Effects of the first embodiment will now be described.

(1-1) The user device 12 sets the display position of the provided object 42 in accordance with the position of the virtual camera 34 and the position of the avatar object 41 corresponding to the distributing user 13A based on the identification information and display request of the provided object 42 sent by the viewing user device 12B. Consequently, even if the position and orientation of the virtual camera 34 are changed by the distributing user 13A, the intermediate display object 45 and the rear display object 46 are displayed at positions that use the position of the virtual camera 34 and the position of the avatar object 41 as a reference, so the distributing user 13A can easily notice the provided object 42. This allows the distributing user 13A and the viewing user 13B, who share the virtual space, to smoothly interact with each other through the display request of the provided object 42.

(1-2) The output controller 17 sets the display position of the provided object 42 within a display area corresponding to a display attribute associated with the identification information of the provided object 42. Therefore, even if the user device 12 receives a display request for a large number of provided objects 42 in a short period of time, the provided objects 42 are displayed in different display areas in accordance with the display attributes, so that the provided objects 42 can be restrained from overlapping and becoming difficult to see.

(1-3) The output controller 17 sets the display position of the intermediate display object 45, which is one of the provided objects 42, between the position of the virtual camera 34 and the position of the avatar object 41. This makes it possible to display the intermediate display object 45 near the avatar object 41, regardless of the position of the avatar object 41 in the virtual space 30. In addition, because the virtual camera 34 is easily directed toward the avatar object 41, the intermediate display object 45 is easily displayed on the screen. This makes it easy for the distributing user 13A to notice the provided object 42.

(1-4) The output controller 17 sets the display position of the intermediate display object 45, which is one of the provided objects 42, to a position at the specified distance L1 from the avatar object 41. Therefore, by shortening the specified distance L1, it becomes easy for both the avatar object 41 and the provided object 42 to be included on the screen.

(1-5) The output controller 17 sets the display position of the two-dimensional object 49, which is one of the provided objects 42, to a position at the specified distance L2 from the virtual camera 34 within the field of view Z1 of the virtual camera 34. Therefore, the two-dimensional object 49 is continually displayed on the virtual space screen 60.

(1-6) The output controller 17 sets the display position of the rear display object 46, which is one of the provided objects 42, to the rear of the avatar object 41. By dividing the display areas of the intermediate display object 45 and the rear display object 46 in this way, the provided objects 42 can be displayed without overlapping.

### Second Embodiment

A second embodiment of the information processing system, program, and information processing method is described below.

In the second embodiment, the distributing user device 12A performs collaborative distribution in which multiple distributing users 13A accomplish distribution together. Hereinafter, the same reference numerals will be used to designate the same parts as in the first embodiment, and detailed description thereof will be omitted.

Collaborative distribution will now be described. The distribution of a video including images of each avatar object 41 corresponding respectively to each of multiple distributing users 13A is called collaborative distribution. In this embodiment, each distributing user device 12A can be a distribution source device.

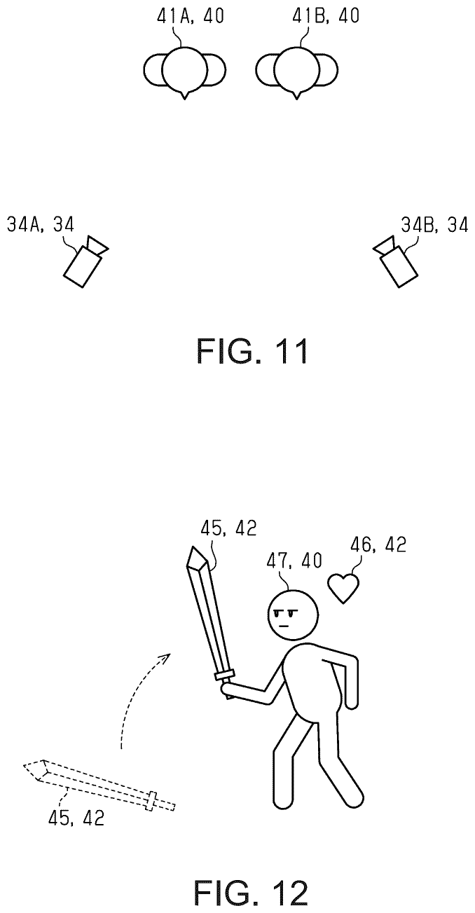

As shown in FIG. 11, virtual cameras 34A and 34B are set for avatar objects 41A and 41B, respectively. Each distributing user 13A can set the position and orientation of the respective virtual camera 34A or 34B. That is, the images displayed on the display 109 of each distributing user device 12A may differ depending on the distributing user device 12A.

When viewing a video, the viewing user device 12B can select a distributing user 13A. The viewing user device 12B generates a virtual space image based on the position and orientation of the virtual camera 34 set by the distributing user 13A selected by the viewing user 13B.

Alternatively, all viewing user devices 12B viewing videos of collaborative distribution may generate a virtual space image according to the position and orientation of the virtual camera 34 set by a specified one of the distributing users 13A. In this case, the distributing user 13A who sets the virtual camera is called a host user, and the other distributing users 13A are called guest users.

### Operation

The operation when the viewing user device 12B provides a provided object 42 will now be described.

The communicator 16 of the viewing user device 12B transmits to the management server 11 information that can identify the distributing user 13A to whom the provided object is to be provided, along with identification information and a display request for the provided object 42. This allows the distributing user device 12A used by the distributing user 13A to set the display position of the provided object 42 in accordance with the position of the virtual camera 34 and the position of the avatar object 41 corresponding to the distributing user 13A.

This process will be explained in detail. The display request and identification information of the provided object 42 selected by the viewing user 13B are sent to the management server 11. At this time, the communicator 16 sends information that can identify the distributing user 13A that is the target of the provided object 42. This information only needs to enable identification of the distributing user 13A, and does not necessarily have to be a user ID. For example, this information may be information that can enable identification of the distribution room. In other words, the viewing user 13B provides the provided object 42 to the distributing user 13A selected by the viewing user 13B.

The management server 11 sends information including the identification information of the distributing user 13A, the identification information of the provided object 42, and the display request to the user device(s) 12 that is the target of the transmission. User devices 12 that are the target of transmission may be all the distributing user devices 12A and all the viewing user devices 12B. Alternatively, the user devices 12 that are the target of transmission may be only the distributing user device 12A of the distributing user 13A and the viewing user device 12B of the viewing user 13B who watches the video distributed by that distributing user 13A.

The communicator 16 of the distributing user device 12A obtains information including the identification information of the distributing user 13A, the identification information of the provided object 42, the display request for the provided object 42, and the identification information of the viewing user 13B who made the display request from the management server 11 (step S1). In addition, upon receiving the display request for the provided object 42, the communicator 16 specifies a display attribute of the provided object 42 (step S2).

The output controller 17 displays the provided object 42 at a position corresponding to the display attribute (step S3). The output controller 17 identifies the distributing user 13A based on the identification information of the distributing user 13A received in step S1. The output controller 17 then displays the intermediate display object 45 and the rear display object 46 based on the position of the avatar object 41 corresponding to the identified distributing user 13A and the position of the virtual camera. Similar to the first embodiment, the output controller 17 also displays the two-dimensional object 49 and the attached object with reference to the avatar object 41 to be displayed.

For example, suppose that when a first distributing user 13A and a second distributing user 13A are performing distribution, a first viewing user 13B, who is viewing the video distributed by the first distributing user 13A, requests the display of a provided object 42. In this case, the intermediate display object 45 provided by the first viewing user 13B is displayed between the position of the virtual camera 34 set by the first distributing user 13A and the position of the avatar object 41 corresponding to the first distributing user 13A. Similarly, an intermediate display object 45 provided by a second viewing user 13B is displayed between the position of the virtual camera 34 set by the second distributing user 13A and the position of the avatar object 41 corresponding to the second distributing user 13A.

The viewing users 13B may be able to change at least one of the position and orientation of the virtual camera 34. In this case, the intermediate display object 45 provided by the first viewing user 13B is displayed between the position of the virtual camera 34 set by the first viewing user 13B and the position of the avatar object 41 corresponding to the first distributing user 13A, which is the display target of the intermediate display object 45. Similarly, the intermediate display object 45 provided by the second viewing user 13B is displayed between the position of the virtual camera 34 set by the second viewing user 13B and the position of the avatar object 41 corresponding to the second distributing user 13A.

As a result, the viewing user device 12B of the first viewing user 13B can display the provided object 42 provided to the first distributing user 13A, as well as the provided object 42 provided to the second distributing user 13A if the latter is included in the field of view Z1 of the virtual camera 34.

According to the second embodiment, the following effects can be obtained in addition to the effects described in (1-1) to (1-6) of the first embodiment.

(2-1) In the second embodiment, the viewing user device 12B transmitted to the management server 11 information enabling identification of the distributing user 13A to whom the provided object 42 is to be provided, together with the display request. Therefore, even in a collaborative distribution in which multiple avatar objects 41 are displayed on the screen, the distributing user 13A can recognize a provided object 42 provided to himself or herself.

### Third Embodiment

A third embodiment of the information processing system, program, and information processing method is described below.

In the third embodiment, the distributing user device 12A distributes a video of a game played by the distributing user 13A. In this embodiment, the management server 11 executes the process of managing the progress of the game, but a server other than the management server 11 may execute the process. Hereinafter, the same reference numerals will be used to designate the same parts as in the first embodiment, and detailed description thereof will be omitted.

The distributing user device 12A executes game processing based on the operation of the distributing user 13A in a virtual space in which multiple objects are arranged. The type of game is not particularly limited. For example, the game may be a role-playing game, a shooting game, an action game, a racing game, a fighting game, a training simulation game, a fishing game, a love simulation game, a puzzle game, a card game, a sports game, a rhythm game, or the like.

As shown in FIG. 12, the distributing user device 12A changes at least one of the position and orientation of the virtual camera 34 based on operations by the distributing user 13A, similar to the first embodiment. The distributing user device 12A changes the position of a game character object 47 corresponding to the distributing user 13A based on operations by the distributing user 13A. The game character object 47 is included in the broad definition of the character object 40. The output controller 17 of the distributing user device 12A generates an image including the character object 47 and other objects.

The video can be distributed using one of the above-mentioned methods. For example, in the client rendering method, the distributing user device 12A transmits game progress information to the management server 11 in addition to the coordinates of each object, similar to the first embodiment. The game progress information may include at least one of identification information of a reached or cleared (achieved) stage, score, parameters associated with a character object, parameters associated with a user, identification information of an opponent, action information of a character object or an opponent, and winning or losing. The character object may reflect the movement of the distributing user 13A. In this case, the distributing user device 12A transmits motion data to the management server 11. Alternatively, the character object may not reflect the movement of the distributing user 13A. In this case, the output controller 17 operates the character object based on the operation of the distributing user 13A on the input device 110, and transmits information indicating the movement of the character object to the management server 11. The management server 11 transmits information or motion data indicating the movement of the character object to the viewing user device 12B. Alternatively, the distributing user device 12A may transmit the generated video to the viewing user device 12B via the management server 11.

### Operation

An operation when the viewing user device 12B provides the provided object 42 will be described. An example of the provided object 42 in this embodiment is an object that can affect the game played by the distributing user 13A. For example, the provided object 42 is an item used in the game. The effect of the provided object 42 may be advantageous or disadvantageous to the distributing user 13A in playing the game. Another example of the provided object 42 is an object that does not directly affect the game played by the distributing user 13A, such as a message to the distributing user 13A.

The communicator 16 of the viewing user device 12B transmits identification information of the provided object 42 selected by the viewing user 13B and a display request to the management server 11. At this time, the viewing user device 12B may transmit identification information of the viewing user 13B to the management server 11.

The management server 11 transmits the received identification information of the distributing user 13A, the identification information of the provided object 42, and the display request to each user device 12.

As shown in FIG. 9, the communicator 16 of the user device 12 acquires the display request for the provided object 42 from the management server 11 (step S1).

Upon receiving the display request for the provided object 42, the communicator 16 specifies a display attribute of the provided object 42 (step S2). The provided object 42 in the game may be any of an intermediate display object 45, an attached object, a rear display object 46, and a two-dimensional object 49.

The output controller 17 displays the provided object 42 at a position corresponding to the display attribute (step S3). For example, the output controller 17 displays the intermediate display object 45 based on the position of the character object 40 and the position of the virtual camera 34.

The intermediate display object 45 may be attached to the character object 40 based on the operation of the distributing user 13A. In other words, the intermediate display object 45 may also have the function of an attached object.

For example, as shown in FIG. 12, if the intermediate display object 45 is a weapon item such as a sword, the output controller 17 displays the intermediate display object 45, which is a weapon item, between the character object 40 and the virtual camera 34. When the distributing user 13A selects the intermediate display object 45, the output controller 17 displays the weapon item in association with a hand part of the character object 40.

The output controller 17 may also display a provided object 42 that changes a parameter associated with the character object 40 or the user 13. In the example shown in FIG. 12, a rear display object 46 that increases the health point value of the character object 40 is displayed. Each time this rear display object 46 is displayed, the health point value of the character object 40 increases.

In a game in which distributing users 13A compete against each other or against an NPC (Non Player Character), the greater the number of display requests, the higher the probability of winning. Note that NPCs are characters that are not operated by a player. This motivates the distributing users 13A to increase the number of viewing users.

When a game is played in which distributing users 13A compete against each other, the management server 11 may have distributing users 13A who are expected to have a similar number of viewing users play against each other. A viewing user 13B may register a distributing user 13A in the management server 11 as a favorite user 13A. The management server 11 can obtain the number of registrations in which the distributing user 13A has been registered as a favorite user 13. The management server 11 may select distributing users 13A whose difference in the number of registrations is within a specified range as opponents.

In addition, if a provided object 42 is provided without any restrictions in the game, the provided object 42 may not be used or the game balance may become unbalanced. For this reason, as described above, a price may be set for the provision of the provided object 42. For example, a higher price may be set for a provided object 42 that contributes more to victory, such as by increasing the number of coins or points consumed. Alternatively, the management server 11 may set the number of times each provided object 42 can be provided. For example, the number of times a “sword” weapon item can be provided per battle may be set to “1 time” or the like. In addition, the number of times a rear display object 46 that increases the health point value can be provided per viewing user 13B in one battle may be set to “3 times” or the like.

According to the third embodiment, in addition to the effects described in (1-1) to (1-6) of the first embodiment, the following effects can be obtained.

(3-1) In the third embodiment, a distributing user device 12A distributes a video of a distributing user 13A playing a game. A viewing user device 12B transmits a display request for a provided object 42 that affects the game. This allows the viewing user 13B to participate in the game by cooperating with (or hindering) the distributing user 13A even if the viewing user 13B cannot display their own character object 40 in the video. This allows the distributing user 13A and the viewing user 13B to smoothly communicate with each other through a display request for the provided object 42 in the game.

The above-mentioned embodiments can be modified and implemented as follows. The above-mentioned embodiments and the following modified examples can be implemented in combination with each other to the extent that such are not technically inconsistent.
In the second embodiment, a viewing user 13B provides a provided object 42 to a distributing user 13A who is distributing the video being viewed. Alternatively, or in addition to this, the viewing user 13B may specify a distributing user 13A to which the provided object 42 is to be provided. The viewing user device 12B displays a screen including avatar objects 41 corresponding to multiple distributing users 13A. In other words, the field of view of the virtual camera 34 for displaying this screen may include multiple avatar objects 41. The screen includes GUI elements for selecting each distributing user 13A. The GUI elements are buttons or a menu display or the like corresponding to each avatar object 41. The viewing user device 12B accepts an operation of a GUI element for selecting an avatar object 41 by the viewing user 13B. The viewing user device 12B also accepts an operation for making a display request for the provided object 42. If the provided object 42 is an intermediate display object 45, the distributing user device 12A and the viewing user device 12B display the intermediate display object 45 between the position of the avatar object 41 indicated by the viewing user 13B who provides the intermediate display object 45 and the position of the virtual camera 34. If the provided object 42 is a rear display object 46, the distributing user device 12A and the viewing user device 12B display the rear display object 46 behind the indicated avatar object 41.

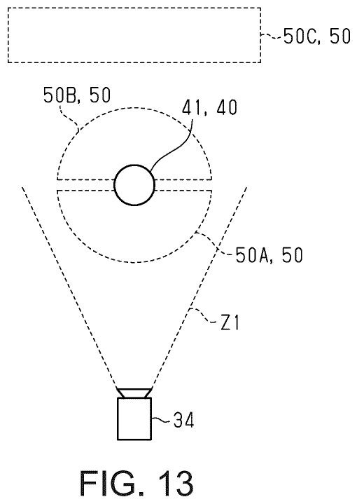

Alternatively, the provided object 42 requested to be displayed by the viewing user 13B may be assigned to the host user. At this time, the provided object 42 may be displayed, as in each of the above-described embodiments, with reference to the virtual camera 34 and avatar object 41 of the distributing user 13A who is the host user. Alternatively, the host user may assign the provided object 42 to the host user's own avatar object 41 or the avatar object 41 of a guest user. In this case, the viewing user device 12B transmits information including the identification information of the provided object 42 and a display request to the distributing user device 12A of the host user via the management server 11. The distributing user device 12A of the host user displays a GUI element (or screen) for selecting a user to which the provided object 42 is to be assigned based on the received information. The host user selects a user 13 to which the provided object 42 is to be assigned based on the GUI element. If the host user selects the host user himself or herself, the distributing user device 12A of the host user transmits the identification information of the host user and the identification information of the provided object 42 to the other user devices 12 via the management server 11. Each user device 12 displays the provided object 42 with reference to the position of the avatar object 41 of the host user as necessary based on the display attribute. If the host user selects a guest user other than the host user, the distributing user device 12A transmits the identification information of the selected user and the identification information of the provided object 42 to the other user devices 12 via the management server 11. Each user device 12 displays the provided object 42 with reference to the position of the guest user's avatar object 41 as necessary based on the display attribute. One or more guest users may be selectable by the host user.
In the third embodiment, the distributing user 13A distributes a game video. Alternatively, or in addition to this, the display process of the provided object 42 may be applied to a game in which multiple users 13 participate. In this embodiment, there need not be distribution of a video, or a viewing user 13B who watches a video. This game may be a MO-(Multiplayer Online) type game. Various users 13 may form a group (also called a guild or party) that advances the game, and may cooperate to advance the game. Alternatively, the users 13 may be opponents who fight against each other. In this embodiment as well, each user 13 can change the position and direction of the virtual camera 34 in the user device 12 that he or she uses. Also, in this embodiment as well, one user 13 provides a provided object 42 to one or more other users 13. The provided object 42 is an object that supports the game play of the other user 13 or an object that encourages the game play of the other user 13, depending on the content of the game. This object is an item having a specified function in the game, an item that increases or restores parameters associated with the user 13, or the like. Alternatively, the provided object 42 may be an object that interferes with the game play of another user 13. In addition, these features are not limited to a game, and the display process of the provided object 42 may be applied to a metaverse space (e.g., where users 13 are located together in a room in a virtual space and converse with each other, or where users 13 attend or participate in a concert together at a live venue in a virtual space), and one user 13 may provide a provided object 42 to one or more other users 13 present in the virtual space.
In each of the above-described embodiments, a user device 12 sets the display position of a provided object 42 according to a display attribute, but the management server 11 may set the display position. In this case, upon receiving a display request for the provided object 42, the management server 11 may specify the display attribute of the provided object 42 and transmit the display request for the provided object 42, the display position thereof, and the identification information of the viewing user 13B to each user device 12.
A viewing user 13B may select a provided object 42 and the display position thereof. As illustrated in FIG. 13, a plurality of candidate areas 50 may be set as areas in which the provided object 42 can be displayed. In FIG. 13, three candidate areas 50A to 50C are set. The candidate areas 50A to 50C may be the same as those in the first embodiment. That is, these may be between the avatar object 41 and the virtual camera 34, behind the avatar object 41, fixed display areas that are not affected by the position of the avatar object 41, or the like. The viewing user device 12B may display the candidate areas 50A to 50C on the display 109. The viewing user device 12B accepts the selection of the provided object 42. Before or after the selection of the provided object 42, the viewing user device 12B accepts a selection operation of one of the plurality of candidate areas 50A to 50C. The viewing user device 12B transmits the selected provided object 42 and the selected candidate area 50A to 50C to the management server 11 together with a display request. Upon receiving this display request, the management server 11 may transmit the display request for the provided object 42, the display position thereof, and the identification information of the viewing user 13B to each user device 12. In addition, the price of the provided object 42 may be determined according to the candidate areas 50A to 50C. As an example, the price of the candidate area 50A between the avatar object 41 and the virtual camera 34 may be higher than the price of the candidate area 50B behind the avatar object 41.

### Provided Object

In the above-described embodiments, the provided objects 42 are the fixed display object 43, the intermediate display object 45, the rear display object 46, the two-dimensional object 49, and the attached object. Alternatively, the provided object 42 may include one of these objects. The provided object 42 may also include at least one of these objects and another object.

### Output Controller

In each of the above-described embodiments, the output controller 17 of the user device 12 distributes and enables viewing of the video using the client rendering method. Alternatively, the video may be distributed and viewed using any of the above-described methods other than the client rendering method. The browser rendering method is a method in which the distributing user device 12A and the viewing user device 12B display the video using an independent web browser stored in the storage 104. At this time, the distributing user device 12A transmits video data and the like to the management server 11. The user device 12 that displays the video receives, from the management server 11, web data that is written in a markup language such as HTML (Hyper Text Markup Language) or the like and uses CSS (Cascading Style Sheets), JavaScript (registered trademark), or the like. A web browser program launched on the user device 12 renders avatar objects and other objects using JavaScript running on the browser. In this method, model data and the like of the avatar objects are not stored in the user device 12. In the case of the browser rendering method, an application does not need to be installed on the user device 12. Alternatively, an application including an in-app browser may be installed on the user device 12.

In the browser rendering method, at least one of the commonly known methods such as static rendering (static server-side rendering), server-side rendering, client-side rendering, prerendering (CSR with prerendering), and hydration rendering (SSR with (Re) hydration) can be used as a method for generating a file for displaying the virtual space screen 60 by rendering. Rendering here refers to interpreting data written in a markup language or the like and calculating the arrangement of image elements and characters to be displayed on the virtual space screen 60.

In static rendering, a web server stores a static HTML file in advance. The web server may be included in the management server 11. The user device 12 downloads a static HTML file from the web server. The user device 12 displays the rendered HTML file on the display 109 to display the virtual space screen 60. In server-side rendering (SSR), the web server performs rendering and the like in response to a request from the user device 12, and transmits the rendered HTML file to the user device 12. The user device 12 displays the downloaded HTML file on the display 109 to display the virtual space screen 60. The web server includes an application server. In client-side rendering (CSR), the user device 12 performs rendering by executing JavaScript (registered trademark). At this time, the user device 12 downloads a simple HTML file from the web server, and also downloads the necessary JavaScript (registered trademark) and CSS files. In pre-rendering, which is a type of CSR, the user device 12 generates and records some HTML files in advance, and downloads and renders the necessary content from the web server in response to a request. In hydration rendering, the web server generates and records HTML files that have not been rendered. The user device 12 downloads an HTML file from the web server, and also downloads and renders the necessary data based on the HTML file. In each of the above-described methods, the user device 12 may obtain the necessary data from the management server 11 instead of the web server.

The video distribution method is a method in which the distributing user device 12A generates video data. Specifically, the distributing user device 12A uses motion data and the like to draw objects and generate video data, substantially similar to the image processing in the client rendering method. The distributing user device 12A also transmits the encoded video data and audio data to the management server 11. The management server 11 transmits the video data and audio data to the viewing user device 12B. The viewing user device 12B displays the video on the display 109 based on the video data received from the distributing user device 12A.

The server distribution method is a method in which the management server 11 generates video data. The management server 11 receives motion data and audio data from the distributing user device 12A. The management server 11 then generates output data for outputting the video based on this data. The management server 11 transmits the generated output data to the distributing user device 12A and the viewing user device 12B. The distributing user device 12A and the viewing user device 12B output the video to the display 109 based on the received output data.

In this way, either the user device 12 or the management server 11 is responsible for generating data for outputting the video. The data to be generated differs depending on the distribution method. The device responsible for generating the data can be changed depending on the distribution method.
The virtual space 30 may be one in which a screen of the virtual space is displayed, or may be one in which events such as live shows and matches are held. Alternatively, the virtual space 30 may be an entertainment facility such as a virtual store or an amusement park. Alternatively, the virtual space 30 may be one in which communication among users 13 is possible.

### Management Server

The management server 11 may be a single server device equipped with multiple virtual servers, or may be a combination of multiple physical servers. For example, the management server 11 may be a combination of a server having a distribution management device 20, a server having a user information management device 21, a server having a user management information storage 22, and a server having a provided object information storage 23.

### Avatar Object

In each of the above-described embodiments, the user device 12 renders the avatar object 41 corresponding to the distributing user 13A using emote data or tracking data that detects the movement of the distributing user 13A. This allows the movement of the distributing user 13A or the movement selected by the distributing user 13A to be reflected in the avatar object 41. Alternatively, or in addition to this, the user device 12 may temporarily or continuously draw the avatar object 41 without using the tracking data and emote data. The output controller 17 controls the avatar object 41 based on the input operation of the user 13. The avatar object 41 performs an action according to instructions input by the user 13. In this aspect, when drawing a large number of avatar objects 41 in the virtual space 30, the load of the drawing process of the user device 12 can be reduced.

### Users

In each of the above-described embodiments, the distributing user 13A refers to a user who transmits at least one of information related to images (video) and information related to audio. For example, the distributing user 13A is a user who performs video distribution alone (first embodiment) or a user who performs collaborative distribution in which multiple people can participate (second embodiment). Alternatively, the distributing user 13A may be a user who hosts or organizes a video chat or audio chat that multiple people can participate in and/or watch, or an event (party, or the like) in a virtual space that multiple people can participate in and/or watch. In other words, the distributing user 13A can be rephrased as a host user, organizing user, or a promoting user.

On the other hand, the viewing user 13B refers to a user who receives at least one of information related to video and information related to audio. However, the viewing user 13B not only receives the above-described information, but can also react to the information. For example, the viewing user 13B is a user who views a video distribution or collaborative distribution. Alternatively, the viewing user 13B may be a user who participates in and views at least one of a video chat, an audio chat, or an event. Therefore, the viewing user 13B can be called a guest user, a participating user, a listener, a viewing user, a supporting user, or the like.

### Information Processing System

In each of the above-described embodiments, the user device 12 is an information processing device such as a smartphone, a mobile phone, a tablet terminal, a personal computer, a console game machine, a wearable computer such as a head-mounted display, or the like. Alternatively, the information processing system may be a system provided in a studio for video distribution. The information processing system includes an information processing device, a server, a sensor unit attached to the body of the distributing user 13A, a tracking system that detects the position of the sensor unit, an operation device, a speaker, a display, and the like. The tracking system may be equipped with a multi-axis laser emitter that emits a pulsed laser light for synchronization. The sensor unit includes a sensor that detects laser light, and detects its own position and orientation while synchronizing with the synchronization pulse.

Next, technical ideas that can be understood from the above-described embodiments and other examples are described below.

[1] An information processing system for displaying an image of a virtual space viewed by a distributing user who distributes a video and a viewing user who views the video, wherein:
a distributing user device used by the distributing user comprises:
   a setting device that changes at least one of a position and a direction of a virtual camera in a three-dimensional virtual space;
   a communicator that acquires information transmitted from a user device used by the viewing user, the information being (i) identification information for identifying an object selected by the viewing user and (ii) a display request for the object; and
   an output controller that sets a display position of the object according to the position of the virtual camera and a position of a character object corresponding to the distributing user based on the identification information of the object and the display request, and displays on a display device a virtual space image in which the object is arranged at the display position.

[2] An information processing system for displaying an image of a virtual space of a game viewed by a plurality of users, the information processing system comprising:
a setting device that changes at least one of a position and a direction of a virtual camera in a three-dimensional virtual space, based on an operation of the users;
a display request transmitter that transmits, based on an operation of one of the users, identification information for identifying an object selected by the one of the users and a display request for the object;
a display request receiver that receives the identification information for identifying the object and the display request for the object; and
an output controller that sets a display position of the object according to the position of the virtual camera and a position of a character object corresponding to the first user based on the identification information of the object and the display request, and displays on a display device a virtual space image in which the object is arranged at the display position.

[3] An information processing system for displaying an image of a virtual space viewed by a first user and a second user, the information processing system comprising:
a setting device that changes at least one of a position and a direction of a virtual camera in a three-dimensional virtual space;
a communicator that acquires information transmitted from a user device used by the second user, the information including (i) identification information for identifying an object selected by the second user, (ii) designation information that designates a position or area in which the object is to be displayed, and (iii) a display request for the object; and
an output controller that sets a display position of the object according to the designated position based on the identification information of the object, the designation information, and the display request, and displays on a display device a virtual space image in which the object is arranged at the display position.

### Explanation of Symbols

10 Information processing system
11 Management server
12 User device

1. An information processing system for displaying an image of a three-dimensional virtual space viewed by a first user and a second user, the information processing system comprising:
circuitry configured to
change at least one of a position and a direction of a virtual camera in the virtual space;
acquire information transmitted from a device used by the second user, the information including (i) identification information for identifying an object selected by the second user and (ii) a display request for the object; and
set a display position of the object according to the position of the virtual camera and a position of a character object corresponding to the first user, based on the identification information of the object and the display request, and display on a display a virtual space image in which the object is arranged at the display position.

2. An information processing method executed by circuitry, the method comprising:
changing at least one of a position and a direction of a virtual camera in a three-dimensional virtual space;
outputting a virtual space image, which is an image of the virtual space as seen from the virtual camera, to a display viewed by a first user;
acquiring information transmitted from a device used by a second user, the information including (i) identification information for identifying an object selected by the second user and (ii) a display request for the object; and
setting a display position of the object according to the position of the virtual camera and a position of a character object corresponding to the first user, based on the identification information of the object and the display request, and outputting the object to the display position.

3. The method according to claim 2, wherein
a display attribute is associated with the object, and a plurality of the display attributes is associated with respective display areas in the virtual space, and
the display position of the object is set within the display area corresponding to the display attribute associated with the identification information of the object.

4. The method according to claim 2, wherein
the display position of the object is set to be between the position of the virtual camera and the position of the character object.

5. The method according to claim 4, wherein
the display position of the object is set such that a relative distance from the character object to the object is a specified distance.

6. The method according to claim 4, wherein
the display position of the object is set to be within a field of view of the virtual camera and such that a relative distance from the virtual camera to the object is a specified distance.

7. The method according to claim 2, wherein
the object is a first object,
the first object is displayed between the position of the virtual camera and the position of the character object, and a second object is displayed whose relative distance from the virtual camera is a specified distance, and
the first object is a three-dimensional object and the second object is a two-dimensional object.

8. The method according to claim 2, wherein
the object is a first object,
the first object is displayed between the position of the virtual camera and the position of the character object, and a second object is displayed whose relative distance from the virtual camera is a specified distance, and
a display time of the first object is set to be longer than a display time of the second object.

9. The method according to claim 2, wherein
the object is a first object,
the first object is displayed between the position of the virtual camera and the position of the character object, and a second object is displayed whose relative distance from the virtual camera is a specified distance, and
a price for making the display request for the first object is higher than a price for making the display request for the second object.

10. The method according to claim 2, wherein
the display position of the object is set to be behind the character object in a depth direction based on the virtual camera.

11. The method according to claim 2, wherein
the second user is a viewing user who views a video including an image of the character object, and
the method further comprises:
(receiving data for displaying the video sent by another device used by the first user, the first user being a distributing user who distributes the video from a server;
transmitting the identification information for identifying the object selected by the viewing user and the display request for the object to the server; and
outputting the video based on the data for displaying the video.

12. The method according to claim 11, wherein
the video includes images of the character objects corresponding to a plurality of the distributing users, and the virtual camera is set for each of the character objects, and
the method further comprises transmitting to the server information identifying the distributing user to whom the object is to be provided, together with the identification information of the object and the display request, to cause the other device used by the distributing user to set the display position of the object in accordance with the position of the virtual camera and the position of the character object corresponding to the distributing user.

13. The method according to claim 2, wherein
the object is a first object, and
when a second object is displayed between the first object and the virtual camera, the display position of the first object is set to be closer than the second object to the position of the virtual camera.

14. A non-transitory computer-readable medium storing thereon a program for causing circuitry to:
change at least one of a position and a direction of a virtual camera in a three-dimensional virtual space;
output a virtual space image, which is an image of the virtual space as seen from the virtual camera, to a display viewed by a first user; and
acquire information transmitted from a device used by a second user, the information including (i) identification information for identifying an object selected by the second user and (ii) a display request for the object, wherein
the circuitry sets a display position of the object according to the position of the virtual camera and a position of a character object corresponding to the first user, based on the identification information of the object and the display request, and outputs the object to the display position.
